(19) United States
(12) Patent Application Publication
(10) Pub. No.: US 2010/0057560 A1
(43) Pub. Date: Mar. 4, 2010

(54) Methods and Apparatus for Individualized Content Delivery

(75) Inventors: Ann Skudlark, Westfield, NJ (US); Pradeep Bansal, Monmouth Junction, NJ (US); Carroll W. Creswell, Basking Ridge, NJ (US); Colin R. Goodall, Rumson, NJ (US); Guy J. Jacobson, Bridgewater, NJ (US); Andrea Skarra, Chatham, NJ (US); Christopher Volinsky, Morristown, NJ (US); James W. Watson, Mendham, NJ (US)

Correspondence Address: AT & T LEGAL DEPARTMENT - PG, ATTN: PATENT DOCKETING , ROOM 2A- 207, ONE AT &T WAY, BEDMINSTER, NJ, 07921, US

(73) Assignee: AT&T Labs, Inc., Austin, TX (US)

(21) Appl. No.: 12/204,440

(22) Filed: Sep. 4, 2008

(51) Int. Cl. G06Q 30/00

(52) U.S. Cl. 705/14.49

(57) ABSTRACT

Systems and techniques for predicting customer response to content and selecting content for delivery to particular customers in accordance with the predictions. As information is delivered to and received from a plurality of customers over multiple communication channels, data streams representing communications between providers and customers are analyzed and selected data extracted therefrom. Linkages are created between data collected from the different channels and data are anonymized. The data are analyzed to create a customer response predictor for each customer that models customer behavior and predicts customer response to advertisements. As content, such as advertisements, are to be delivered to a destination, information from a predictor created using data collected from a customer associated with the destination is used to select appropriate content.

### FIELD OF THE INVENTION

The present invention relates generally to improvements to delivery of content to consumers. More particularly, the invention relates to improved systems and techniques for analyzing information relating to customer characteristics and real time conditions and activities, and using the results of the analysis to choose and deliver advertising or other content predicted to meet customer needs.

### BACKGROUND OF THE INVENTION

Advertising has long been an essential component of the delivery of many types of information and entertainment to consumers. Advertisers are willing to pay to have their messages delivered, and the income an information provider receives from advertisers pays a significant portion, or all, of the cost of producing and delivering content desired by consumers.

Delivering advertising to consumers, and inducing them to pay attention to the advertising, has traditionally been surrounded by problems. Print advertising is easy for consumers to ignore, and consumers frequently tend to regard broadcast advertising as an imposition. Advances in technology have brought new ways to deliver advertising, along with new ways to avoid advertising. Internet web pages frequently include more or less obtrusive advertisements, and techniques are continuously developed to allow consumers to ignore or avoid advertising. For example, pop-up advertising on Internet web pages can be automatically blocked. In another example, digital video recorders allow consumers to fast forward through television commercials.

In addition, the response rate for nearly all advertising is relatively low. The great majority of consumers are not interested in a particular advertisement, and traditional techniques have depended on general distribution of advertising in the hope of eliciting responses from a relatively small portion of the population to which an advertisement is presented. Paying for the presentation of advertising to persons who have no interest in the subject matter of the advertisement is costly and inefficient.

Many of the problems of consumer resentment and avoidance of advertising and poor consumer response can be avoided if advertising can be sufficiently closely tailored to the interests of a particular consumer to which it is directed. Advertising has long been focused based on the nature of the medium or content through which or with which it is presented, so that magazines directed to a particular readership carry advertising for products intended to appeal to that readership, television shows carry advertising of interest to the expected audience for the show, and web pages are analyzed to determine their content, and advertising messages chosen to appeal to readers having interest in that content are presented. Such techniques, however, continue to result in the presentation of advertising to many consumers who have no interest in it.

The more closely advertising can be tailored to the interests of each person to whom it is directed, the less likely it is that the effort and expense put into the advertisement will be wasted, and the less likely it is that the recipient will resent or avoid the advertising material.

Modern entertainment and information delivery is more and more a two way function. A provider delivers information to a consumer, and also receives information from the consumer. This information may include consumer identity information and information relating to consumer requests and activities. For example, a provider furnishing a service or package of services to a subscriber may receive information such as subscriber name, address, financial information, and subscription details, as well as other information that the subscriber may wish to furnish. Such information may include, for example, entertainment, advertising, or other content preferences. In addition, a provider necessarily receives information relating to the services requested by and furnished to the subscriber. An entertainment provider receives requests for content and delivers the content, and the fact and time of the request, and the time of the delivery are known at some point. A customer may request pay per view programming, may select between various channels, may pause, fast forward, and save shows using digital video recording (DVR) services, and may take other actions relating to selecting and viewing programming that is provided. The actions taken by the customer with respect to programming offerings can be collected and examined in order to gain insight into customer preferences and needs.

Mobile communication providers use a great deal of information relating to customer activities, including the initiation and receipt of various communications between customers, requests for services such as games, music, entertainment, and information, and other content.

An Internet provider receives and uses information relating to the various sites that a subscriber visits, as well as the activities the customer engages in at these sites. Enormous amounts of information and entertainment are currently delivered over the Internet, and the scope and variety of information and entertainment that is delivered continues to increase.

In addition, wireline usage also provides significant real time customer information. Wireline subscription information can provide information similar to the subscription information for other services, and wireline usage information may provide significant information relating to customer receptivity to advertising, with calls to numbers mentioned in advertisements being of particular interest.

### SUMMARY OF THE INVENTION

Among its several aspects, the present invention recognizes the need for improved delivery of content, such as advertising, entertainment, news, alerts, and other content, to consumers in contexts such as described above and as rapid delivery of content to consumers continues to evolve in the future. One present embodiment of the invention is presented primarily in terms of selecting and delivering advertising, but it will be recognized that any desired form of content maybe selected and delivered using the teachings of the present invention.

In one aspect, the invention takes advantage of the information that is available for each individual consumer using an information delivery service or a combination of information delivery services. A provider collects customer data, including customer profile data that may be provided when a customer subscribes or at other times, as well as information relating to the activities of each customer. Such information may be collected in the context of entertainment service delivery, such as cable, satellite, or other subscription television, communication services, such as wireline or wireless communication, and broadband services, such as Internet access and entertainment services delivered over broadband packet delivery networks. The information may be collected by monitoring data streams transferred between a customer and a provider in the context of delivering services. The information for each customer is used to develop a model for customer response to advertising, in order to predict with as much specificity as possible the advertisements that will be in accordance with a customer's interests and to which the customer will respond. Privacy is increasingly important to many consumers, and significant increases in acceptance of any mechanism involving the collection and analysis of customer data can be expected if customers are assured that such use of their data will take place both with their consent and while maintaining the security of financial data and the like and the confidentiality of personal or sensitive information. Further, acceptance may hinge on consumers perceiving that the results of uses such as described herein will lead to results beneficial to them. Privacy concerns surrounding customer behavioral data are of particular interest, and the present invention provides mechanisms to provide security and anonymity for such data, both to satisfy customer privacy concerns and to assure compliance with laws and regulations relating to customer privacy.

Two broad classifications of data may be envisioned. One is data that changes relatively infrequently, such as customer identity, address, a real or virtual address of equipment used to receive services, financial information used for payment, and any additional information that may be requested from and supplied by a customer. Such information may be stored in a customer profile, and this profile data may be stored with greater or lesser permanency. In addition, real time customer data reflecting customer interactions and behaviors are collected. Such data may be collected by examining data streams from each of a plurality of services used by a customer, including, for example, television, wireless, wireline, and broadband services. The real time customer data and the customer profile data are managed so as to guard against improper use of the compiled data, and used to create one or more predictors and models that allow for prediction of a customer's responsiveness to advertising content and value to advertisers.

Customer static data and customer real time data are used to create a customer behavior predictor used to estimate a customer's likely response to advertisements and other content, and the customer's value to sellers of various products and the value of the customer's positive response to other content providers. Factors including interests of advertisers and other content providers in reaching particular categories of consumers and satisfying particular consumer interests, and consumer data calculated to identify consumers that advertisers and other content providers wish to reach, are used to create appropriate models. Customer classification data, which may be taken from customer static data, as well as estimated using customer models, may also be used to place a customer into categories of interest to advertisers and other content providers.

When a customer is engaging in activities appropriate to the selection and delivery of content adapted to the customer, the activity in which the customer is engaging is monitored and conditions appropriate for delivery of selected content are noted as they arise. For example, a television program or web page may include advertisement insertion points. To take another example, while the customer is planning an itinerary for a trip, a determination may be made that a customer would appreciate particular information, such as delivery of a set of links to sources of information about points of interest at the destination, or an alert of an impending event, such as a storm or road closure.

When an appropriate point for delivery is identified, appropriate predictions are made and these predictions are used to select appropriate content. Particularly when an advertisement is to be delivered, delivery mechanisms are preferably controlled in such a way that an advertiser does not have access to the predictor associated with a customer. Instead, information relating to advertisements is supplied to an advertising manager, which uses the predictor to inform the selection.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates a service delivery system employing systems and techniques according to an aspect of the present invention;

FIG. 2 illustrates details of a data management center according to an aspect of the present invention; and

FIG. 3 illustrates the steps of a process of entertainment and communication service delivery, customer analysis, and advertisement delivery according to an aspect of the present invention.

### DETAILED DESCRIPTION

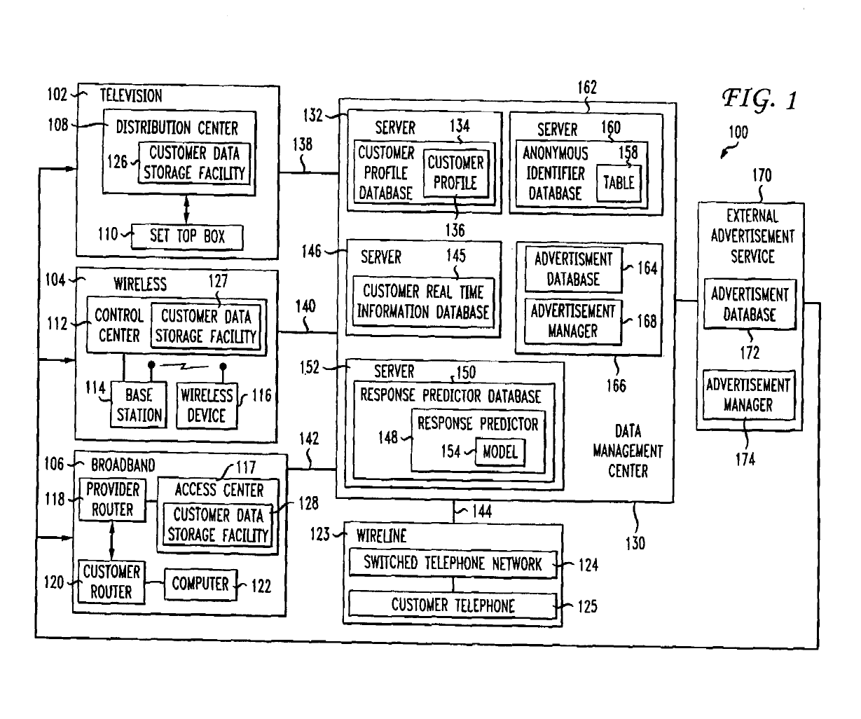

FIG. 1 illustrates a block diagram of a system 100 providing content selection and delivery using systems and techniques according to an aspect of the present invention. In the present example, three different services involving the transfer of information between a customer and a provider are famished to the customer. Data are collected relating to the customer, involving characteristics such as demographic and income groups, and preferences. Additional data are collected through the customer's use of the various services and activities engaged in during use of these services. The data are used, such as through statistical modeling, to predict a customer's interest in and responsiveness to content, and appropriate content is selected for delivery to the customer.

In the present exemplary embodiment, the services provided to the customer are delivered by a television service provider 102, a wireless service provider 104, and a broadband service provider 106. Television services may include live and delayed television, such as digital video recording, delivered in an entertainment format. Television services may also include Internet protocol television ultimately delivered to the customer as an audio video stream. In the present embodiment, television services are implemented by a television distribution center 108 communicating with a customer set top box 110. Wireless services may include voice and data communication such as is typically delivered over wireless devices, and may include text messaging, instant messaging, music and entertainment delivery, Internet access, and the numerous other services delivered over wireless devices, and are represented here as a wireless control center 112 in communication with an exemplary base station 114, which in turn communicates with a customer wireless device 116. Broadband services may include data services delivered over an Internet connection, illustrated here as provided to a customer through an access center 117, connected to plurality of routers of which provider router 118 is an example. The provider router 118, and other similar routers, provide a plurality of customers with access to broadband services, with access being provided to an exemplary customer through the provider router 118 communicating with a customer router 120, with an exemplary customer computer 122 connected to the customer router 120. The provider router 118 may connect to the customer router 120 through an appropriate connection, such as a digital subscriber line (DSL) connection, cable connection, fiber optic connection, or the like. The access center may also suitably provide access to customers through other mechanisms. For example, a customer who is traveling may reach the broadband provider 106 through dialup access, or may reach services provided by the broadband provider 106 but delivered over an alternative connection such as a hotel local area network or a public or private wireless connection.

Data transfer between the television distribution center 108, wireless control center 112, and access center 117, respectively, and the respective customer devices served by them, provide a rich source of information that provide data for capture and analysis for the purpose of delivery of individualized content. In addition, the customer may also be served by a wireline telephone system 123, comprising a telephone switching system 124 providing a connection to a customer telephone 125.

The distinctions between mechanisms used to deliver television services, wireless services, and broadband services are becoming more and more blurred, but it is useful to draw distinctions between the different services because they continue to demarcate contexts of use. A customer using television services can be thought of as engaging in one set of activities, a customer using wireless services can be thought of as engaging in another set of activities, and a customer using broadband services can be thought of as engaging in a third set of activities. These sets of activities may exhibit overlap, but useful distinctions can be drawn between the activities, particularly through analysis of customer usage.

In order to select and deliver advertising and other content to customers, data related to the content and to characteristics and activities of the customer may be collected and analyzed. For example, in the case of advertising, three broad categories of data used to manage advertisement selection and delivery may be envisioned. These categories are advertising and promotion data, customer static data, and customer dynamic data.

Advertising and promotion data include data relating to the advertisements that are to be delivered to customers. Such data include classification of advertising and promotions by product and service types, target audience profiles such as demographics, expected or desired audience behavior grouped by media, location, and other audience details, and campaign details, such as start and end dates, geographic coverage, nature of advertising, presence and nature of any special promotions such as rebates and coupons, and other relevant details.

Customer static data include information relating to customer characteristics that change relatively infrequently. Such information may include, for example, age, income, education level, household size and composition, home location, financial information, and other similar information. Customer static data may also include information relating to various media subscriptions, such as wireless, broadband, and entertainment services, as well as membership in various real and online communities, such as clubs and online social networks. Additional data may include information relating to ownership and use of various products and services linked to advertising and promotion categories. Such data may suitably be stored in data storage facilities 126, 127, and 128, implemented as part of the distribution center 108, the control center 112, and the access center 117, respectively.

Customer real time data constitute another important category of customer data. These data are gathered by analysis of activities engaged in by the customer, and may include ongoing tracking and updating of media usage, programs and time viewed, and notation of whether viewing was live or recorded. Additional data include minutes of use by time of day and day of week of calls, and destination profiles characterizing calls. Still other data include online usage, such as sites visited, pages viewed, actions taken, uploads and downloads, use of email, instant messaging, text messaging, use of Internet radio, streaming music, streaming video, and use of web content areas such as news, sports, finance, weblogs, shopping, and other activities. Such data may be advantageously correlated to each individual in the household using the various media and services. Still further data include call detail data in the case of wireless and wireline usage. Such call detail data may be used to measure responsiveness, geographical location of the customer, and exposure to ads and promotions of various types across media and response to ads and promotions by medium including print. For example, if an advertisement solicits a call to a telephone number, call detail data will indicate whether such a call was made, the time and duration of the call, and the location of the customer making the call.

Further data include media search and purchase history, including Internet protocol television, content subscription services, web, phone, and the like. Additional data that may be collected includes purchase behavior in person to the extent that this can be known. Such data may include store sales, restaurant visits, and other information.

Still further data may include information received by the customer or relevant to the customer, with such data indicating conditions of interest to or affecting the customer. For example, a customer may receive weather, news, or event information, and such information may be used to identify advertisements, information, and other content that may be of interest to the customer. Examples of such content might be a link to a weather or traffic conditions page if real time data indicate severe weather, or road construction or traffic delays. Other examples of such content might be advertisements for concert or sports tickets, if a customer subscribes to event reminders and such event reminders indicate upcoming events of interest to the customer. In addition, once the location of the customer is known, information relevant to the customer's environment may be collected from other sources. Weather, traffic alerts, road construction alerts, relevant news events, and additional information relating to or affecting a location can be gathered once it has been determined that a customer is in or may be traveling to that location, and such information can be used to select appropriate content.

Real time customer data are collected by examining data transferred between the service providers 102, 104, and 106, and the customer devices used to communicate with those providers. For example, data transfers between the set top box 110 and the distribution center 108, data transfers between the wireless device 116 and the base station 114, and data transfers between the customer computer 122 and the provider router 118 all provide sources of data that can be captured as appropriate. In addition, as noted above, additional information not received from the customer but relevant to the customer may be received by the data management center from its own sources of information.

As discussed in greater detail below, storage of customer data, particularly real time data, is performed in such a way to preserve data security and prevent improper linking of such data with identifiable customer information. Data transfers may be monitored at any appropriate point through which data passes or at which information is both sent and received. Such monitoring is performed for the purpose of providing individualized content based on the preferences of the customer and under conditions chosen by or otherwise acceptable to the customer, and with appropriate steps being taken to safeguard the privacy of the customer.

Examples of points at which data transfers may be monitored are the distribution center 108, the control center 112, and the access center 117. Examples of customer activities that provide insight into customer behavior, and that produce data transfers that may be monitored, are sending and receiving email on a home or office computer or on a wireless service, watching streaming video over a broadband service, ordering a pay per view movie from a television service, listening to streaming music over a broadband service or a wireless service, shopping for travel from a home computer connected to the Internet, reading online newspapers over an office computer, and numerous other activities. Additional data may include data related to a customer's environment. For example, a customer may subscribe to news and weather updates, and information relevant to the customer's interests may be identified and used to evaluate the sort of content to be delivered to the customer.

Customer data are passed to a data management center 130 and processed to obtain information such as demographic data, geographic data, behavioral data, and contextual data. Such information may be extracted through analysis of both static and real time information. Static information may be stored in the customer data facilities 126, 127, and 128, with appropriate data from each storage facility being furnished to the data management center 130 as needed, and with real time information being supplied by monitoring whichever customer/provider interface points are appropriate.

Demographic data relates to various population and interest groups into which the customer may be classified. Geographic information relates to the customer's home location, the customer's current location at any particular time, and the customer's traveling patterns, both over extended periods and over shorter periods, such as a current period. Such information may be derived from a combination of static and real time information, with the customer's home location being given when services are initiated and information reflecting a customer's travels being collected through observation of customer activities. A customer's historical traveling patterns may reflect his or her traveling preferences, while a traveling pattern over a shorter current period may reflect a current trip. The data furnished to the data management center 130 are also analyzed to generate behavioral data and contextual data, that is, data relating to customer activities and the circumstances under which these activities are undertaken.

The data management center 130 processes the data it receives in order to determine what advertising content is most suitable for the customer. The data management center 130 may create a customer response predictor for each customer. Such a response predictor may include an enumeration of various classifications to which a customer may belong, as well as a statistical model that can be used to predict customer behavior. The data management center 130 may suitably provide for a server 132 hosting a customer profile database 134, including an exemplary customer profile 136 for a customer under consideration. The customer profile 136 and similar profiles may suitably be assembled using data from the storage facilities 126, 127, and 128, respectively. A profile such as the profile 136 may suitably include information supplied by the customer and maintained for purposes of service delivery and payment, as well as additional information that may be explicitly provided by the customer. For example, the customer profile 136 may include customer name, customer address, stored financial information, and information relevant to customer preferences and interests, such as entertainment preferences indicated by customer responses to questions presented to the customer.

In order to gain customer acceptance for the collection and processing of customer data in order to predict customer behavior, details of the collection and use of data may preferably be presented to customers and the customers may be given an opportunity to choose not to participate. Therefore, at appropriate times, such as at initial subscription to one or more services using the data management center 130 and periodically thereafter, an appropriate notification may be presented to a customer. This notification may be generated by the server 132, for example, and customer responses received may be stored in the customer profile 136. The notification may be routed to one or more of the television distribution center 108, the wireless control center 112, and the broadband access center 117, and may describe the data whose collection is proposed and the intended use of the information, the proposed benefits to the customer from the collection and use of the information, and measures taken for the security and anonymization of the data.

The notification may suitably be presented in the form of a selection interface, allowing the customer to decline to participate in the proposed data gathering and analysis, or to exclude particular categories of data from gathering and analysis. For example, a customer may choose to allow the creation and use of a customer profile comprising information such as subscription information, customer demographics, preference information, and other information provided by mechanisms such as responses to questionnaires, but may choose not to allow the gathering and analysis of behavioral data. This selection interface may be configured to provide for adherence to applicable legal standards, privacy policies, and customer service agreements, and may provide appropriate disclosures conforming to such standards, policies, and agreements. For example, the use of wireline customer proprietary network information (CPNI), such as call detail records, is subject to significant controls in many jurisdictions, and has traditionally been a focus of concerns about customer privacy. Thus, for example, the selection interface may require a customer to specifically waive safeguards on the use of CPNI in order for such information to be used for individualized content delivery. The selection interface may suitably be maintained by an entity operating the data management center 130, or providers supplying information services to customers, and both it and the information gathered in order to manage individualized content delivery can be updated in response to changes in legal standards, privacy policies, service agreements, and stated selections and preferences of individual customers. As part of the selection interface, or as a separate interface form, the customer may also be given the opportunity to enter preferences and areas of interest. Customer preference information may include shopping preferences, goods or services of interest to the customer, and additional information relating to the customer's purchasing choices and preferences. Any such information collected from customer inputs may be stored in the customer profile 136. It will be recognized that notifications to customers may be presented in numerous different ways, and that numerous alternative choices and combinations of choices may be presented to the customer. For example, the system 100 may be designed so as to require a customer's explicit election to participate. As another example, for a household with multiple customers, opportunities to make selections may be presented to a single customer or to multiple customers identified individually.

Additional information relating to customer preference is gathered by monitoring activities undertaken by the customer while using the various services furnished by the providers 102, 104, and 106. As noted above, data transfers between each of the providers 102, 104, and 106, and its respective customers, may be monitored. The set top box 110 may be used to select pay per view or other special programming, communicating with the delivery center 108 to request delivery of programming to the customer. The set top box 110 may also advantageously be designed to communicate with the distribution center 108 when a channel selection is made. The communications between the set top box 110 and the distribution center 108 may be represented as a data stream 138, illustrated here as received by the data management center 130 from the distribution center 108.

The wireless communication provider 104 receives numerous communications from customers, with the communications including information such as addresses to which calls and text messages are being directed, selections of services that are being requested from the provider 104, addresses from which communications are being received, the customer's location when a communication is made, and numerous other elements of information. These transfers of data may be represented by a data stream 140, illustrated here as received by the data management center 130 from the control center 112. The broadband service provider 106 receives numerous communications from a customer, such as website addresses, searches, requests for downloads, requests for streaming content, requests for advertisements, responses to advertisements, and numerous other similar communications that provide insight into a customer's behavior and preferences. The transfers between a customer and the broadband service provider 106 may be regarded as a data stream 142, illustrated here as received by the data management center 130 from the access center 117.

The wireline telephone switching system 124 also handles numerous communications from the customer using the telephone 125. Such transfers may be regarded as a data stream 144. Such data provide valuable information relating to customer ordering behavior. Examination of such behavior can provide immediate insight into the effectiveness of advertisements, because many advertisements call for a response that involves requesting information or placing an order by calling a telephone number such as a toll free number. By noting the presentation of an advertisement requesting the calling of a particular number, followed by placing of such a call after presentation of the advertisement, a clear indication of the effectiveness of the advertisement can be gained.

The data streams 138-144 are analyzed for the insight they provide into customer preferences and behavior, and this insight can be used to identify advertisements to which a particular customer will respond and other content in which the customer may be interest or which will meet the needs of the customer. The information provided by the data streams 138-144 continually changes as the customer proceeds with his or her activities, and proper analysis of the data streams can therefore provide immediate insight into the customer's current interests, needs, and behavior.

Customers may regard information related to their entertainment, communication, and online activities as personal and private. Therefore, the use of such information by another party may advantageously be conducted in such a way as to assure customers that their privacy will be preserved. If privacy concerns are properly satisfied, customers may be quite interested in receiving information relating to products and services of interest to them, and in the prospect that such information will take the place of advertisements for products and services in which they have no interest.

Therefore, the data management center 130 preferably manages information received from the data streams 138-144 in such a way that these data are held securely during the time that they are retained, and mechanisms may be provided to allow the information to be put to a specific use that renders the specific elements of information unidentifiable when put to such use. One advantageous technique for such use is for creation or refinement of a customer behavior model or predictor. The information received from the data streams 138-144 may be used to inform the model, but managed in such a way that the specific nature of the information so used cannot be determined from the model or predictor.

The data streams 138-144 are examined and information provided by the data streams 138-144 is extracted and stored. Such information may be held, for example, in a customer real time information database 145 hosted by a server 146, but this information is held securely, and may be discarded when no longer needed. In addition, categories of data that a customer has chosen to exclude from collection may be excluded from storage in the database 145. Various techniques are used to isolate information in the customer real time information database 145 from any information identifying the customer from whom the information has been collected. Sufficient identifying information is maintained so that content may be properly routed, but this identifying information need not identify the specific customer to whom content is routed. The need to provide service will likely require that information be maintained that will associate a customer with a routing destination, but this information may preferably be held in isolation from any mechanism for analyzing customer data and will also be secured in such a way as to render it inaccessible to unauthorized parties.

Because only a single customer is being addressed here for the sake of simplicity, only that one customer is discussed in connection with the customer real time information database 145. In typical operation, a customer real time information database such as the database 145 will store information for numerous customers, with each customer's information stored in an entry consolidating the information for that customer. Each customer's entry will typically not include identifying information for the customer, but instead will include a unique identifier that distinguishes the information from that of other customers. The identifier will ultimately allow insight gained from the information to be associated with a particular routing destination, but strict measures to preserve security and anonymity, described in greater detail below, may be taken to prevent linkage of the collected data with any customer, and to prevent the insight gained from the use of the data that may be correlated with any information that can be identified with a customer, except under terms disclosed to and acceptable to the customer.

The information for a particular customer is used to create a response predictor 148 that is based on the content extracted from the data streams 138-144, information from the profile 136, and other available information relating to the customer, and may, as discussed in greater detail below, use modeling techniques employing information relating to the customer under consideration as well as other customers.

The response predictor 148 may suitably be held separately from the servers 132 and 146 used for the profile 136 and the customer real time information database 145, respectively. The response predictor 148 for a particular customer may comprise program and data elements that may be stored, for example, in a response predictor database 150 hosted on a server 152, and referred to as a single entity for convenience, but it will be recognized that the data and operations comprising the response predictor 148 may be distributed in any way desired. Moreover, it will be recognized that while only one response predictor 148 and one model 154 is illustrated here, typically numerous response predictors and models will be stored in the database 148, with one combination of response predictor and model being stored for each customer.

The response predictor 148 may include data, such as signatures, that classify the customer as belonging to particular groups, such as demographic and interest groups, as well as data that predict likelihood of responses to advertisements in particular categories. The response predictor 148 also includes a response model 154, which may suitably be a mathematical predictor of customer responses to advertisements and other content. The model 154 may be used to generate predictors or signatures indicating the likely appeal of various advertisements to the customer, or the likely appeal and appropriateness of other forms of content to the customer, and these predictors or signatures may employed to choose appropriate advertisements and other content for the customer. Alternatively or in addition, characteristics of an advertisement may, for example, be used as inputs to the model 154, and the model 154 can generate results used to refine the signatures of the predictor 148, or to report a score or other indicator of an advertisement's likely appeal to the customer. The model 154 is preferably difficult to trace to any of the data that was analyzed to produce the model 154. Similarly, the various signatures need not include references to the information on which they were based. For example, a signature may indicate an interest in a particular type of music, and an intensity level for that interest, but need not include a reference to information used to estimate the interest. Such information may be obtained by examining the duration of streaming music sessions, identifying the songs listened to, classifying various songs by artist, genre, or other criteria, and examining the number of songs of a particular category listened to over time.

The response predictor 148 for each customer is preferably held in isolation from information used to identify a routing destination for content selected by the predictor 148. Intermediary mechanisms are used to associate a prediction made by the predictor 148 with the destination to which an advertisement is to be directed. The response predictor 148 may, for example, be associated with an anonymous identifier that is the same as the universal identifier used to associate data collected from a customer. A separate table 158, suitably stored in an anonymous identifier database 160 hosted on a server 162, may be used to correlate the anonymous identifiers with the routing addresses with which they are associated. The table 158 may operate in a secure way, such as through a one-way hash function, so that data correlation can proceed in only one direction. The table 158 may be constructed, for example, so that it is possible to use the table 158 to determine a routing destination given an anonymous identifier, but not possible to determine an anonymous identifier given a routing destination. The predictor 148 for a customer A, therefore, will not be made accessible through possession of a routing destination associated with the customer A. All such information is suitably secured to prevent disclosure to unauthorized persons, such as by encryption as well as storage in a location or locations to which access is controlled.

Once data stored in the database 145 have been used to create or refine a predictor 148 and model 154, the data may be subject to review so as to be discarded in order to further enhance customer privacy. In order to refine the predictor 148 and the model 154 with newly collected data, previously collected data may need to be used for correlation. However, once data are no longer needed for such correlation, it may be discarded, and in implementations in which previously existing data are not used in refining or updating the predictor 148 and model 154, such data may be discarded once the predictor 148 and model 154 have been created.

The data management center 130 may also suitably include one or more databases storing content for delivery to a customer, and may implement mechanisms to deliver that content. In the present exemplary embodiment, an advertisement database 164, hosted on an advertising server 166, is discussed, together with an advertising manager 168. It will be recognized, however, that numerous different forms of content may be delivered based on predictions of customer interests and needs, such as information, alerts, entertainment, and other forms of content.

In the exemplary case here, focusing on advertisements, the advertisement database 164 may host advertisements from a variety of sources, with each advertisement being associated with indicia that may be used to predict its level of interest to a customer. A customer signature for a customer may be used to match against indicia for advertisements to select appropriate advertisements for the customer. Response models such as the model 154 may also be used to generate indicia such as scores and indicators that may be used to select appropriate advertisements by matching against the indicia associated with the advertisements.

The data management center 130 may also implement an advertisement manager 168. The advertisement manager 168 has access to the advertisement database 164 and the customer response predictor database 150. The various service providers 102, 104, and 106 may suitably implement periodic delivery of advertisements to customer devices such as the set top box 110, the wireless device 116, and the customer computer 122, and at appropriate times may issue advertisement requests to the data management center 130. Requests are processed by the advertisement manager 168, which uses an appropriate predictor from the customer response predictor database 150, such as the predictor 148, to select appropriate advertisements from the advertisement database 164.

The advertisement manager 168 consults the predictor 148 in order to determine what advertisement should be delivered. The predictor 148 may be used in numerous different ways to make such a determination. For example, the predictor 148 may be used to indicate the customer's inclusion in various broader or narrower categories, so that advertisements appropriate to those categories may be delivered. To take another example, the advertisement manager 168 may present indicia associated with one or more advertisements to the predictor 148, and the predictor 148 may compute a suitability score for each advertisement. The advertisement manager 168 may present one or more advertisements according to the suitability score provided by the predictor 148. For example, the advertisement manager 168 may present the advertisement having the highest score, or may assemble a queue of advertisements ranked by score. As a further alternative, advertisements may be presented at random so long as their suitability exceeds a predetermined threshold. Numerous other alternative criteria for presentation may be contemplated.

An alternative mechanism for presentation of advertisements includes providing information to an external advertising server such as the server 170, which may be operated by an outside entity. The external advertising server 170 may host its own advertisement database 172 and advertisement manager 174 and may request information from the data management center 130. The advertisement manager 174 may provide advertisement information to the data management center 130, which may use response predictors and models for a plurality of customers to determine the suitability of various advertisements for various customers. The data management center 130 may then return directions to the advertisement manager 174, directing the routing of particular advertisements to particular destinations.

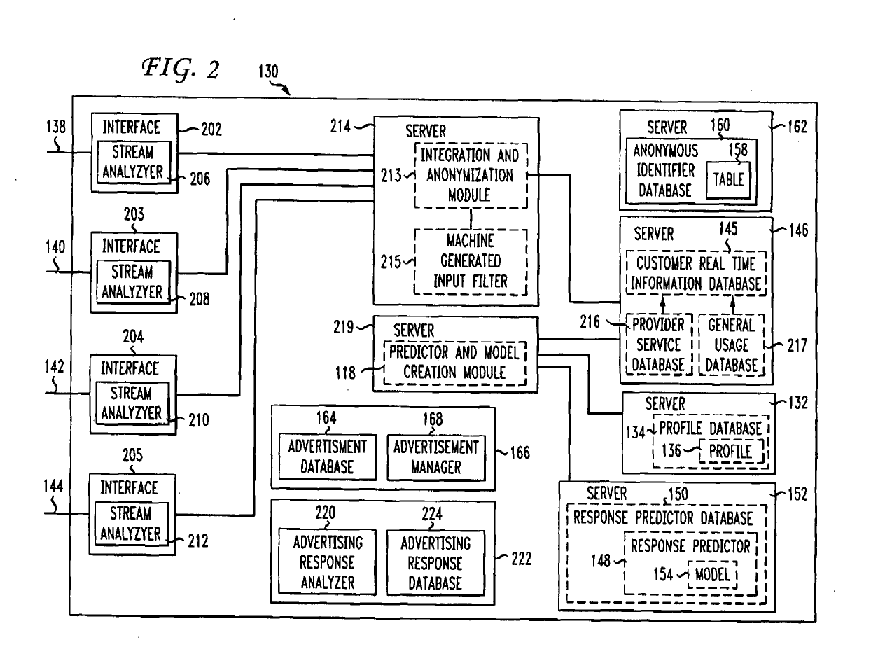

FIG. 2 illustrates additional details of the data management center 130. In the present exemplary embodiment, the data management center 130 provides interfaces 202, 203, 204, and 205, for receiving the data streams 138-144. The interfaces 202-205 examine the data streams 138-144 and select appropriate data for storage in the customer real time information database 145. Each of the interfaces 202-205 may suitably comprise a data processing system such as a computer having processing and data storage and communication capabilities. It will also be recognized that while four separate interfaces are illustrated here, the operations performed by the interfaces may be performed by a single interface or may be consolidated with other operational elements. The interfaces 202-205 may suitably implement stream analyzers 206, 208, 210, and 212, respectively. One particularly useful and powerful system that may be used is a stream database employing a structured query language to provide search and analysis techniques. The stream analyzers 206-212 provide mechanisms to search and merge data streams, and use storage and processing facilities to provide for temporary storage and to allow for such searching and merging. Each stream is monitored for desired data, and appropriate data are retained and directed to the customer real time information database 145. Before data gathered by the stream analyzers 206-210 are passed to the customer real time information database 145, the data are linked and anonymized by an integration and anonymization module 213, which may suitably be implemented by a server 214.

In practice, the various streams 138-144 will include data from many customers, and data will need to be examined in order to identify the customer with which it is associated. Data collected from different channels are likely to have identifying characteristics that differ to a greater or lesser extent. The integration and anonymization module 213 therefore examines one or more of a number of different identifying elements that may appear in data. Depending on the identifying elements included, data from the various streams 138-144 may be able to be precisely, or else more or less probabilistically, identified as being associated with the same customer. Further, data may be associated with individual use in one service, as in the case of a cellular telephone, and with shared use among a group in another service, such as household use of television services. Both the probabilities of matching and the group structure are incorporated into the databases supporting individualized content delivery, and into prediction model formulation, fitting, and application.

A substantial amount of data that may be received at the data management center 130 may comprise automatic machine interactions. Automatic machine interactions give little or no insight into a customer's preferences, and are therefore advantageously excluded from consideration. The integration and anonymization module therefore employs a machine generated input filter 215, which analyzes the data received and discards machine generated data. Considerations employed by the filter 215 include the time between inputs. If inputs are received at very short intervals, faster than the capability of a human being, these inputs can be determined to be machine generated. Other possibilities include automated machine generated requests or responses while the customer is away from his or her device, or automated requests or responses made according to a schedule or according to predetermined criteria. For example, in the case of broadband usage, system software may be updated at the same time every night or every week, or stock quotes may be retrieved at specified intervals during the trading day. Such usage can be identified by examining an experimental group of participants in order to identify patterns indicating machine generated inputs. The participants may be given additional capabilities to specifically define whether inputs are human generated or machine generated.

Categories of identifying information frequently associated with television, wireless, and broadband services are as follows. For television and high speed Internet access such as cable, identifying information may include Internet protocol address, media access control address, and billing account number. For digital subscriber line (DSL) broadband service, identifying information may include service address, customer name, and Internet protocol address. For wireless service, identifying information may include mobile identification number and contact telephone number. Wireline service information may also be available, and may include billing telephone number, working telephone number, and contact email address. For all services, available identifying information may be expected to include customer location, repository affiliate identifier, and billing name and address.

Usage information may also be expected to be available. For wireline and wireless communication, call detail records may be available, as well as information relating to a wireless user's Internet activities, such as wireless application protocol (WAP) transaction information or other information relating to wireless Internet access, however that access may be achieved. For digital subscriber line usage and television or high speed Internet usage, remote authentication dialup customer service, or RADIUS, session information may be available, as well as packet transfer information, indicating the number of packets transferred to and from the customer. For television, set top box usage may be available, and for DSL, information gathered by an asynchronous digital subscriber line engineering tool (ADEPT) may be available.

In order to provide for rapid linkage between activities, it is highly desirable to respond rapidly to changes in data. Billing data typically lag behavior, so that the integration and anonymization module 213 employs techniques that can accommodate changes. Probabilistic record linkage may employ appropriate statistical modeling and scoring approaches. A model may be created from a predetermined set of data comprising a set of known matches and nonmatches between members of a set of data elements, such as those described above, that carry some information about the customer. A statistical model is used to determine the best set of weights to apply to the characteristics of the two sets of records to determine a match. Such models are tuned via a holdout sample to minimize the errors of incorrect matches and incorrect nonmatches.

Each identifier, such as those listed above, preferably has an associated date and time that can be used to draw conclusions relating to its accuracy. Some elements such as working telephone number change rarely. Other identifiers such as an IP address associated with a particular DSL customer for a particular session change frequently. The integration and anonymization module 213 is therefore designed so take advantage of slowly changing identifiers while also using more rapidly changing identifiers.

Some degree of inaccuracy can be expected to exist for correlation of identifiers, and usage information can be used to enhance accuracy. The presence of some level of activity indicates that a data record is current, and dates of first and last use also indicate the availability of the customer generating the activity to receive an advertisement. In addition, various data elements can be found in the usage information described above. Call detail records, for example, typically include a particular telephone number or mobile number. Set top boxes are associated with a particular MAC address. RADIUS data items are associated with a particular customer name. A set of features can be extracted from two sets of records for which matches and mismatches are known and a model fitted to predict a match. Predictors will include closeness of identity measures, such as string similarity measures of various name and address elements and variables derived from usage.

Incorporating usage data to enhance the record linkage model has a strong potential for increasing match rates even when many of the screen identifiers are missing or inaccurate. Patterns derived from the usage data can serve to uniquely identify a target.

In order to preserve customer privacy, all identifying information received in the data streams 138-144 may preferably be removed, and an anonymous identifier or other mechanism for correlating information may be used instead. In order to be usable for predicting customer responses, sufficient identifying information is maintained or created to allow data from the same customer to be recognizable as coming from the same customer, even if the particular customer from whom the data come is not identifiable. In addition, one or more mechanisms are maintained so that an advertisement that was selected based on data coming from a customer can be routed back to that customer.

The integration and anonymization module 213 may suitably create an anonymous identifier common to information relating to a particular customer, and allowing for routing and processing of information so that information relating to a customer is processed to give insight into the activities of that customer, and so that advertisements selected based on that information can be routed to the customer. All data are encrypted while stored or transmitted, to protect the data from disclosure to unauthorized persons. One possible technique is to subject identifying data, such as name and address information or account information, to a one-way hash function that results in a unique identifier. A one-way hash function operates on an input to create a fixed-size string. Suitably, in the present case, a cryptographic one-way hash function is used. A cryptographic hash function maps inputs over its output range with a high degree of uniformity, and also creates outputs that are practically indistinguishable from randomized outputs. The output of a cryptographic one-way hash function cannot be processed to yield its input without an inordinately great investment of time and computing resources. Examples of cryptographic one-way hash functions that may be used to create identifiers are MD5 and SHA. Salting may be performed in order to increase resistance to attacks. A random string may be concatenated with the input string, and the product of this operation may then be subjected to the hash function to yield the identifier. Thus, the identifier cannot be processed to yield the original information used to create it, but a table, such as the table 158 correlating the identifier to a routing destination associated with the source of the information, or other mechanism for associating an identifier with a destination, may be employed to provide information to be used in routing an advertisement to an appropriate destination. The hash function may produce an output string as an identifier, and the output string may be used as an index to the routing destination in the table 158.

Data that may be stored in the customer real time information database 145 include a wide variety of information. Examples of information that may be stored include use of streaming content, including duration of sessions and type of content used. Streaming content may include video and music services, and a customer's use of such content provides insight into his or her entertainment choices. If the customer subscribes to a music service, the type of music received over that service gives considerable insight into his or her music choices. Similarly, viewing of television programs or clips also gives insight into customer preferences. Additional data may include downloaded content, types of websites visited, use of instant messaging systems, frequency of response to advertisements, and types of advertisements responded to. Still further data may include an Internet protocol (IP) address or addresses from which transmissions are made. For example, if a customer retrieves email or receives content from a subscription service while at a location different from his or her home location, the identity of the customer is known, together with the customer's location. The fact that the customer is away from his or her usual location, together with the specific location, can indicate the customer's receptiveness to information and advertisements relating to the customer's location. If the location of a customer has repeatedly changed, such changes, and the general direction of the changes, may indicate the customer's future destinations, and therefore give insight into which information and services are of interest to the customer on his or her continuing travels.

In the present exemplary embodiment, static customer data, such as customer profile data such as may be stored in the customer profile 136, and real time customer data from the customer real time information database 145 are incorporated into the predictor 148. The data are taken from the customer's broadband, wireless, and television usage, with television usage including Internet protocol television, or IPTV. Examples of data that may be suitably used may be generally grouped into provider service data relating to use of one or more portals and services furnished by a provider, as well as more general usage data taken from the customer's visits to and usage of various sites and services. For clarity in description, provider service data will be described as being preliminarily held in a provider service database 216, while general data will be described as being preliminarily held in a general usage database 217. The data in the databases 216 and 217 will be consolidated into the customer real time information database 145, and these data will be used to create and refine the predictor 148. If desired, for example, if the customer has chosen to exclude particular data categories from consideration, these categories of data may be excluded from storage in the provider service database 216 and the general usage database 217, or may be held in these databases only until it is determined that they are not to be used, in which case they may be discarded from the databases 216 and 217 without being stored in the database 145.

A predictor and model creation module 218, hosted on a server 219, is illustrated here, receives data from the profile 136 and the database 145, and processes the data to create the predictor 148 and model 154.

A model may be characterized as a set of rules or an equation based on factors related to past behavior, and that produces results estimating future behavior. The model may be applied to a current set of alternatives and the probability of success predicted for each. The alternatives that are predicted to provide the greatest likelihood of success can be selected. Detailed data for a particular customer is aggregated to create profiles of customer behavior and conditions relevant to customer behavior. These profiles are then combined with data on customer response to advertisements and other customer behavior responses, including response to selected advertisements. The combined data are used to generate and train a prediction model. The prediction model specifies a mapping from one or more variables that are included in the aggregated customer data to a customer response prediction. Customer data may include longer term and more transient components. For example, longer term components may indicate interests in water sports, blogging, and needlework. Such components are reflective of more generalized activity and lifestyle choices, and may be expected to be of relatively long duration. A more transient component may reflect interest in Honda automobiles. Such an interest may reflect a contemplated new car purchase, and, if so, the customer's responsiveness for information relating to Honda automobiles may diminish once the purchase has been made.

Both sets of components are used in prediction models. The two sets of components imply different granularities of aggregation, which a substantially coarser aggregation for the longer term components.

New detailed data for each customer will typically become available over time. This data may be aggregated and combined with the existing data and prediction models may be refined based on the new data. This new data may be used to update coefficients and terms of the prediction model created from the customer data, as well as to modify the set of responses or behaviors predicted by the model. Such updating may be performed continually or at defined points in time.

For example, an online retailer of bicycling gear might want to increase the number of prospects that click on the retailer's online advertisement. Data may be gathered on prospects who click or do not click on these advertisements. These data may include any behavior that occurred before the ad, selected prospect characteristics, selected advertisement characteristics, and some measures of how recent all of these data are. A statistical model selects and weights various candidate predictors and determines which weighted subset best predicts clicking on bicycle gear ads and/or responding positively in some other manner. The model is applied to a possible set of future advertisements presented on particular sites, or to particular customers. Then the sites with the highest predicted click through rates are selected for actually running the advertisements, or the customers with the highest predicted likelihood of clicking the advertisements are selected for presentation, or both.

Sites and customers numbering in the millions or tens of millions may be available for presentation of a particular advertisement. A model such as the model 154 may generate a score for the advertisement, and this score may be made available for evaluation by an advertiser or may be used in accordance with criteria established by the advertiser. For example, an advertiser may choose to present an advertisement to the 10% of customers having the highest likelihood of clicking on the advertisement, or to customers whose likelihood of clicking the advertisement exceeds a predefined threshold.

Numerous considerations are used in developing a model such as the model 154. For example, previous behavior is frequently found to be a good predictor of future behavior, with more recent behavior constituting a better predictor than very old behavior.

Any model or combination of model features chosen for the model 154 or similar models will typically operate in the absence of complete information about the customers, because it may not be possible or desirable to connect all information for a given customer across all sources. A model will function in the face of partial information about each customer, with the probabilities generated by the model reflecting the completeness or incompleteness of the information related to the customers. In addition, some models may require integration across only a subset of the entire set of data sources, with the models being based on only a subset of the behaviors reflected in the entirety of the data sources.

A large number of potential predictors will typically be available for constructing a model, but a workable model will employ only a subset of the candidate predictors. Statistical analysis may be performed to select a smaller number of predictors having equal or nearly equal predictive power. Such techniques may be applied, for example, to search terms and web site categories, and techniques that may be used include word filters, stop lists, principle components analysis on word frequencies, and other techniques applicable to text mining. One particularly useful predictor, particularly with respect to broadband or wireless Internet access, is frequency of visits to websites related to the advertisement of interest. Such relationships may be identified by statistical testing. Indicator variables may then be constructed using some reasonable number, such as a few hundred, of one way predictors with associated recency measures. Another useful technique is the construction of search word clusters, and this technique can also be extended to clustering web sites visited. Techniques such as neural networks and machine learning may also be employed to develop appropriate models or model components.

One useful technique for creation of a model such as the model 154 is collaborative filtering at multiple scales. Various factors representing generalizations or specific observations about the customer behavior are computed or estimated for the customer, at varying levels of detail. For example, a broad factor might relate to the global popularity of various items that might be advertised, with all customers being estimated to have a higher likelihood of interest in very popular items. A narrower factor might be whether the customer is an early adopter of new technologies, and a still narrower factor based on more specific observations might be based on comparisons between the customer's behavior and expressed preferences against the behavior and expressed preference of other customers. For example, a customer might not have expressed a specific preference about a particular product, but other customers showing behavior patterns similar to the customer in question might show an interest in the product, so that the interest of those customers might be imputed to the customer in question. Such techniques are described in Koren, Bell, and Volinsky, “Improved Systems and Techniques for Modeling Relationships at Multiple Scales in Ratings Estimation,” U.S. patent application Ser. No. 12/107,309, filed on Apr. 22, 2008, assigned to the common assignee of the present invention and incorporated herein by reference in its entirety. Related techniques are described in Koren and Bell, “Systems and Techniques for Improved Neighborhood Based Analysis in Rating Estimation,” U.S. patent application Ser. No. 12/107,449 filed on Apr. 22, 2008, assigned to the common assignee of the present invention and incorporated herein by reference in its entirety.

Observations of customers may be conducted in order to correlate behavior with responsiveness to advertisements. Any behavior directly related to advertisements or responses advertisements is particularly useful. For example, if a customer places an order in response to an advertisement, or shows an interest in viewing an advertisement, the content and nature of that advertisement, and the customer's interest in it, are noted. In addition, observations and information relating to customer interests are also used to predict customer responsiveness to advertisements targeted toward those interests.

As noted above, modeling techniques such as collaborative filtering may be used to correlate characteristics and behavior of customers for whom information relating to responsiveness to particular advertisements and advertisement types is known against customers who are similar in characteristics and behavior but for whom responses to particular advertisements and advertisement types may be unobserved. Observations may be made using sample groups, and the extent to which various characteristics and behaviors correlate with responsiveness to particular advertisement types may be used to determine similarity measures for the customers, and factors such as those described above may be identified that correlate with responsiveness to advertisements. The influence of various factors on responsiveness to advertisements having particular characteristics may be determined, and factors representing behavior and characteristics of a customer in question may be combined in appropriate ways to predict the responsiveness of a customer to advertisements and advertisement categories.

In addition to estimating responses to advertisements, modeling techniques such as those described above may be used to estimate responsiveness to other forms of content, such as entertainment programming. Such estimates of responsiveness may be based on observed behavior and characteristics. Estimates may be made based on ratings, and may include the use of more general behavior and characteristics to enhance or replace ratings based estimates. Entertainment items and other content may be delivered or recommended to a customer based on such estimates. The content that may be delivered or recommended is not limited to entertainment, but may include numerous other types of content, such as news and other informational content based on estimates of the customer's interests and needs, with such informational content being adapted in real time as data are gathered about the customer. For example, the model developed for a customer may come to indicate that the customer bicycles to work during good weather and drives to work during more severe weather, and information delivered to the customer in the morning may be adapted to emphasize traffic alerts when the customer is estimated to be driving to work, but not when the customer is estimated to be cycling to work. As more information is collected about the customer, the customer's behavior may change, and the model may similarly change, with different information being emphasized for delivery.

The predictor and model creation module 218 may suitably undertake a continuous process that generates a model and receives results gathered during the operation of the data management center 130, to evaluate model performance. Data used to generate models may suitably include identified test data, and the test data may be used to evaluate model predictions and the results of the evaluations may be used to replace or refine models, for example, by selecting different predictors or evaluating predictors in different ways.

One useful and relatively compact approach to model creation is the use of signatures. In the present context, a signature is a statistical-based vector summary of historical behavior for a customer, weighted towards recent events, typically using exponential weights. A vector signature related to online activity may contain summaries of browsing habits, including both categorical data components, such as areas of interest and use of services, such as online banking, and continuous data components, such as total duration of browsing, time of day, duration and upload and download volumes on selected classes of sites. A component of a signature may, for example include a list of top 10 types of web sites visited most often together with the duration of visits and volumes of data transferred.

A signature is compact, on the order of thousands of bytes, making it an ideal data structure for scalable applications in online advertising. A signature may be extensible, so that within reasonable limits a signature may grow as more detailed information about a customer's behavior becomes known. Signatures are well suited to large scale computation, supporting modeling as discussed above, and providing for additional statistical information, such as classifying customers in communities of interest. Separate signatures may be defined for each customer and for each customer point of contact with services provided by the system 100, so that customers and websites, television channels, music services, text services, and numerous other services and activities can be linked.

The predictor 148 and the model 154 are created through analysis and processing of relevant information, including information selected from the customer profile 136 and customer real time information database 145, and in the present exemplary embodiment use various techniques such as the ones described above to incorporate data relating to the customer's use of broadband, wireless, and television services.

Examples of broadband data may include subscription information, including account identifier, customer name and address, home and wireless telephone numbers, email address, and other customer identifying information. Additional subscription information may include length of contract, subscription date, and specific contract terms, such as length of contract and service speed contracted for, as well as incidental contract features, such as billing cycle. Further subscription information may include whether the account was ever suspended, whether the account represents a resubscription to the service after some lapse of time, and other relevant information. Additional information gathered at the time of subscription may include demographic data, including age, family composition, gender, geographic location, and other information. Further information may include additional data that may have been supplied at the time of subscription or later, such as responses to questions about customer interests and distinguishing features for each member of a multiple customer household. Such information is typically part of a customer profile such as the customer profile 136.

Behavioral data may be taken from an examination of the logged in use of portals and services furnished by the broadband provider. Metrics may be collected for overall network use, number of active sub-accounts and usage on each sub-account, and percent usage on master account. Further metrics include percent usage on browsers furnished by the provider, webmail usage including messages read and sent, address book usage, and point of presence mail. Still further metrics include usage and customization of portals, including the specific content received through the portals. Such content may include news and information, with metrics being recorded for the various types of such information being received. Additional content may include streaming music, streaming video, games, and other entertainment. Further metrics may be collected for instant messaging sessions, including the number and length of sessions, messages sent, and the number of instant messaging buddies. Still further metrics may be collected for search activities. The data described above may suitably be held in the provider service database 216.

As noted above, more general data relating to uses of services that may not be furnished by the provider may also be collected. Such data are collected from the stream analyzer 208 for storage in the general usage database 217, with the destination being the customer real time information database 145. Such data may include subscriber records, including a subscriber identifier associated with each subscriber, such as the primary email address, and an anonymous identifier associated with each subscriber. The subscriber identifier need not be stored in the customer real time information database 145 or used in the predictor 148. Instead, an anonymous identifier or other appropriate mechanism may be used to correlate such data. Further data may include identification of the network access server being used and the modem brand being used. Additional information may include an anonymous identifier, the IP address from which activities are carried out, a type flag indicating an association of the data with the subscriber or reassignment to a different subscriber, and a timestamp. Additional information may include application subclass records, which report the number of bytes sent and received for each data subclass over some desired period of time, such as a 24-hour period. Application subclasses include, for example, web browsing, uploading and downloading, streaming content, voice over IP, instant messaging, and various other applications.

Additional information includes http session records. For example, details relating to each http connection occurring during a 24-hour period may be recorded. Details may include the anonymous identifier, the operating system being used, the browser being used, times of http requests, server host name, referring web page, bytes transfers in each direction, whether or not the session was encrypted, search terms used with search engines, cookie size in bytes for each cookie transferred, really simple syndication (RSS) feeds access, advertisement broker and destination for each advertisement clicked, categorization of each web host accessed or search conducted.

A set of records relating to each day's activity may be collected, with each event comprising a single record. Each record will include a record type identifier, indicating whether the record is a subscriber record, an application subclass record, an http session record, an IP address record, or some other designated record type.

The data received from the provider service database 216 and the general usage database 217 may suitably be processed periodically and stored in the customer real time information database 145, and data stored in the customer real time information database 145 is used to refine the predictor 148 and the model 154.

Creation and refinement of the predictor 148 may also include the use of static data, which may be stored in such a way as to allow for examination so as to categorize the customer. The static data may, for example, allow easy categorization of the customer into demographic or interest groups.

In addition, the real time data are used to create and refine the model 154. An important part of creating the model 154 involves understanding patterns of behavior of interest to advertisers. A huge range of activities is represented, and patterns of the activities can be identified through various mechanisms. Preferably, data presented by the provider is surrounded with sufficient indicia that the customer's interests can be determined from the acts of accessing such data. For example, a news portal might include indicia relating to the kind of news stories provided, such as general or political news, entertainment news, financial news, or sports news. A shopping portal might include indicia indicating the types of products being considered. A streaming music service might indicate the number and length of music sessions and the types of music being played. Customer response and access to the various services may be correlated with the indicia surrounding the services to generate indications of customer interest. These indications may be expressed in the form of interest scores, for example.

Such indicia may not be available for general usage data, so that different forms of analysis may be used, involving additional examination and interpretation of the content of the data. Such lines of analysis may also be applied to data received through interaction with provider services as well.

An important part of activity analysis is the correlation of visits to particular hosts with particular interests of customers. Such analysis involves the selection of characteristics that are distinctive and predictive, yet also sufficiently prevalent so they can be useful to advertisers.

One approach is to identify or hypothesize a set of advertiser needs. Advertiser behavior may be analyzed, for example, by examining top bids for search terms, costs per click, and other sources to identify important advertiser markets. For example, if a company pays $8.50 to be first in a paid search list on a particular day, a high degree of importance can be ascribed to sales of the product being advertised. The data stored in the customer real time information database 145 can be examined to identify behavior connected with the purchase of that product. Data and characteristics examined may include signatures, community of interest, response to advertisements, and other appropriate information. Data exploration techniques will include visualization, text mining, and other appropriate techniques.

The model 154 may suitably comprise a plurality of response models used to predict a response that an advertiser may be trying to elicit. For example, for a large, complex, and consultative sale the advertiser's client may wish to elicit an inbound call to a particular telephone number. If use of the telephone number can be identified, for example by monitoring a test population, exposure to the advertisement may be correlated with use of the number, and such correlation can be used to build a model. A large set of candidate predictors may be constructed, with the predictors being tested on a selected population sample. If the lift, that is, the gain in response, is sufficient, the fitted equation may be used on a large set of other broadband customers, with advertisements being served to those most likely to respond. For example, indicia relating to an advertisement may be used as inputs to the model 154, and the model may return a response score indicating the likely responsiveness to the advertisement.

Additional information useful in creating the model 154 includes text contained in searches. One aspect of model creation therefore includes examining word combinations to identify predictive patterns. Cluster analysis and correspondence analysis may also be used to group data in meaningful ways.

In addition to collecting broadband data using the broadband interface 204, television data may also preferably be collected using the television interface 202 and wireless data may be collected using the wireless interface 203. The data so collected may also be stored and processed using the customer real time information database 145 and used to create and refine the predictor 148 and the model 154.

The interfaces 202, 203, and 204 may suitably be adapted to conform to the data they receive, and may be adapted to receive and manage packet switched data or other forms of data as appropriate. One example of a television service from which significant customer activity data may be available is Internet protocol television, or IPTV, in which television programming is delivered over a packet switched communication network or channel. The television service 102 may include such capabilities.

IPTV provides enhanced set top box data collection capabilities as compared to conventional television distribution. Information of particular relevance for television advertisers, whether through IPTV or another delivery mechanism, include the identity of the viewer, the viewer's activities using the television service, and the viewer's other activities, including information that may be gathered from the customer's broadband and wireless activities. Subscription information for each viewing household may be incorporated with other information for the same customers in the profile database 134.

The data stored in the customer real time information database will be set top box information. Such information may include the times the box is turned on, the channel that the box is tuned to, time of channel changes, video on demand orders, whether the box has HD capability and whether such a box is tuned to an HD channel, and the use of time shifting capabilities such as DVR capabilities. In addition, data relating to a customer's responsiveness to recommendations may be used. Customer ratings of a program may be solicited and used to estimate a customer's rating of other programming, with programming having a high estimated rating being presented to the customer. Relevant data may include data indicating the customer's responsiveness to ratings and recommendations, such as the customer's willingness to provide ratings, and whether the customer follows recommendations.

An additional data element that may be gathered, which may be particularly useful for television services capable of targeting advertisements to specific viewers, is advertisement responses by the viewer. Such data may be gathered in connection with the television service or from additional services. For example, the customer real time information database 145 will include information relating to the customer's advertising responses, and this information can be used to target television advertisements. As another example, information relating to responses to television advertisements may be obtained. For example, if a television advertisement asks for a telephone call or website visit from a customer, such a call or visit may be able to be noted through the wireless interface 203, the broadband interface 204, or the wireline interface 205, with appropriate information stored in the database 145. In addition, substitutes for wireline telephone calls may be used. For example, users may make voice telephony calls routed over the Internet, and appropriate details of such calls may be captured when relevant. An advertisement on a website may invite a telephone call and may offer an opportunity to place a call by clicking a link, with the call being effected through Internet telephony, or a user may respond to a television advertisement by using Internet telephony to place a call. In such cases, desired details, which may be different than those of a wireline call detail record, may be captured. For example, the fact of a call and the fact that it was responsive to a particular advertisement may be captured, without capturing details of the number called or other aspects of the call that might be present in a call detail record but which may not be needed to estimate customer preferences and behavior.

Monitoring of set top box information may also provide highly detailed viewership information. By noting channel changes, it is possible to determine the changing levels of viewer interest over time and to correlate these changes in interest with the content being delivered. For example, changing away from a channel during advertisement blocks can be noted, along with the channel to which the viewer changed. Also, watching one advertisement but changing away during another can be noted, and the content of the different advertisements correlated with viewer interest. Such information can be used to inform the customer response predictor 148 and the model 154. Identification of customer data can be accomplished in the same way as discussed above, that is, through the use of an anonymous identifier that does not identify the customer.

Wireless services also provide a rich source of data relating to customer activities and preferences. Many wireless telephones and devices provide Internet access through the wireless application protocol, and also provide the ability to send and receive SMS messages, and provide access to various forms of content from the wireless provider and other sources. A wireless service such as the service 104 may capture information on a customer's calling and messaging behavior, and additional wireless device use, at the device level. The data stream 140 providing such information is supplied to the data center 130 through the interface 203. One particularly advantageous feature of wireless information is that a wireless service inherently keeps track of the location of a wireless device when the device is in use, because the location of the base station through which the device is communicating is known. Such location data can be used to understand a customers travel behavior, where the customer spends time, and where the customer is likely to shop, providing useful data for targeting location specific advertisements to the customer.

As noted above with respect to broadband and television services, static data for the wireless subscriber will be available, and may be stored in the profile database 136. Such data may include account identification, the type of plan subscribed to, the number and types of devices included in the account, identifiers for these devices, account start date, length of contract, and billing cycle.

Many customers of wireless devices will typically be expected to engage in a number of wireless application protocol sessions, with each session including device identifier, start time, location of device at the time of request, hostname and IP address of the server, such as a provider server mediating the session, bytes transmitted by and received at the device, search terms used, and type of device, including make, model, and messaging capabilities. For messaging, available data will typically include device identifier, device location, time of sending and receiving of messages, identifier of device to which a message is sent or from which a message is received, length of message, and type of message, such as text, video, picture, or the like. For voice telephone usage, available data will typically include device identifier, time a call is received or initiated, device location, telephone number of other device, and length of call.

Data are collected from the stream 140 and processed for inclusion in the database 145. Data are passed through the analyzer 208, and the data so analyzed and collected are passed in turn to the integration and anonymization module 213 to provide for linkage with data from other sources, and anonymization. Wireless usage information in the database 145 is used to create or refine the predictor 148 and the model 154.

Frequently, the specific identity of a customer of a wireless device, such as the device 116, is not known, particularly in cases in which one device is shared among members of a household. Therefore, the model 154 provides mechanisms for estimating customer demographics, particularly age and gender, because such information is often highly relevant to advertising decisions. A training data set, which may be based on data relating to a population of wireless customers, will use a training data set to develop modeling factors for customer demographics of interest, and these modeling factors will then be implemented for the population of customers. For the particular customer under consideration here, such factors may be incorporated into the model 154. Appropriate variables include the type of device being used, usage level of voice, data, and messaging services, time of usage, community of interest of the customer, websites visited, download and purchase behavior, location data, and other relevant information.

Specific aspects of response modeling related to wireless usage include actions such as clicks on advertisements and telephone calls to a number that may be presented in the advertisement. Historical receptiveness to particular categories of advertisements, as well as response by a customer's circle of friends may also be incorporated into the model 154. Additional factors of interest might be the locations the customer visits, both geographic and as they relate to particular points of interest. Still other factors of interest may include websites visited, overall usage of the wireless device, and other relevant factors. In addition, the model 154 and predictor 148 may include identification of the customer as belonging to a category of interest, such as having an interest in movie or sports information, or visiting a shopping mall.

Wireline services provide further data relating to customer activities and preferences. Such data include subscription information, such as name, address, account identifier and telephone number. Further data include originating and terminating telephone numbers, length and type of call, and communities of interest, such as may be indicated by customers at subscription or at other times. Of particular interest, as noted above, are calls to telephone numbers presented to a customer in advertisements. The timing of such calls may be noted and correlated to the timing of advertisements in which the telephone numbers were presented.

Further data include data relating to the customer's general environment, such as current weather and current events, as well as the customer's responsiveness to advertisements and shopping patterns in particular environments.

Development of customer profiles and models is typically an ongoing process, with refinement of the predictor 148 and the model 154 occurring continuously as customer behavior proceeds. Initial fitting of models may suitably be performed on a training dataset, with randomized tests being conducted with actual customers to improve model accuracy. Predicted response data for a selected population of customers, such as a population of volunteer participants, may be compared with actual response data, with the differences between predicted and actual response used to refine the predictor 148 and the model 154.

Response data may suitably include all available data relating to a response to a presented advertisement, and may reflect both interaction with telephony and messaging services and internet services, such as wireless application protocol services.

Data of various kinds, such as static, dynamic, explicit, implicit, and the like and at various levels of granularity, are obtained and integrated to create modeling profiles that reflect demographics, geography, and general media behavior, as well as specific contextual media activity related to particular products and product categories and other factors of interest to advertisers. The models and profiles are used directly or to create modeled propensities to match with advertising target profiles to determine which advertisements will be served to which customers over which media in which form and at what time. A single integrated model is discussed here, but it will be recognized that separate models may be created for each medium, or a single integrated model may be used to select both the advertisement to be delivered at a particular time and the medium through which it is to be delivered, depending on the desired design of the system 100.

The content selected and delivered using the principles and techniques discussed here need not be limited to advertisements. Systems such as the system 100 may be used to select and deliver one or more of numerous different forms of content, with appropriate adaptations to models and profiles being made so as to achieve accurate and efficient content delivery. Examples of content that may be delivered include entertainment and information content tailored for the customer. For example, analysis of customer activities may indicate that the customer is contemplating vacation travel or a major purchase, and recommendations and information relating to such travel or purchase may be delivered. To take another example, specialized pages of information relating to identified customer interests may be assembled and delivered. For example, if a customer's activities indicate that the customer an enthusiastic bargain hunter, pages of links to items of interest may be assembled. Such links may be taken from discussion forums devoted to shopping and bargain hunting.

As interaction with the system 100 proceeds, customer response and purchase data will be monitored to the extent possible and used to refine the model 154. In addition, aggregated response data may be collected to refine and improve overall data collection and modeling techniques. Frequently, such data will be available in connection with a customer's normal use of the system 100, as much customer shopping activity takes place through mechanisms provided by the system 100. In addition, specially designed trials may be undertaken to collect response data and correlate such data with predictions. Customer shopping behavior more and more takes place across multiple channels, and such behavior may be continually monitored in order to improve understanding of customer behavior as it occurs.

The same sorts of procedures used to refine customer models may also be used to evaluate performance of the system 100, particularly with respect to improvements experienced by advertisers in customer response rates. As noted above, information relating to a customer's responses to advertising may be collected and used to refine predictors and models associated with the customer. This same information can be used to indicate the improvement an advertiser experiences. A response analyzer 220, suitably hosted in a server 222, may collect customer response information. This customer response information may be aggregated in order to provide data for overall response to advertising presentations, and information relating to such responses may be sorted by advertisement, by advertiser, or both. The aggregated customer response information may be stored in an advertising response information database 224, suitably hosted on the server 222. Such customer response information may be compared against baseline response information in order to evaluate the effectiveness of targeted content delivery performed by the system 100.

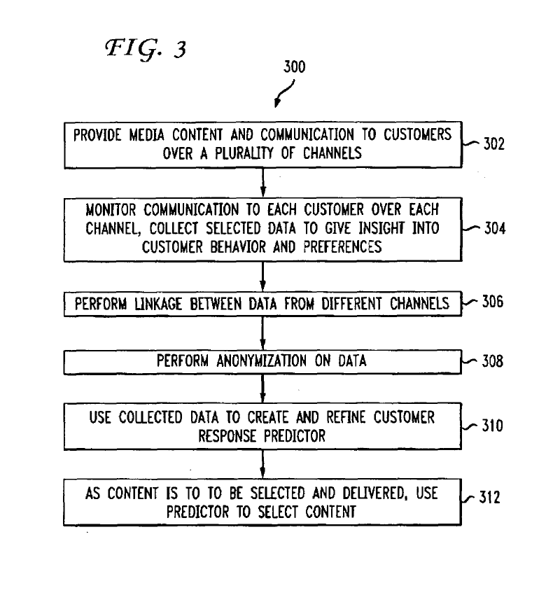

FIG. 3 illustrates a process 300 of customer data collection and content delivery according to an aspect of the present invention. The process 300 may be accomplished using a system such as the system 100 of FIG. 1.

At step 302, media content and communication are provided to a plurality of customers over a number of channels, such as television, wireless devices, and broadband. At step 304, communication to and from each customer over each channel is monitored and selected data are collected that may be used to provide insight into customer behavior and preferences. At step 306, linkage is performed between data collected from the different channels, so that data from each channel from a particular customer can be understood as coming from the same customer. Each data element may suitably be associated with an identifier, with identifiers between channels corresponding to a single customer. At step 308, anonymization is performed on the data so as to remove associations between the collected data and an identifiable customer. Such anonymization will involve retaining sufficient information that an advertisement based on the data can be properly directed, or customer data updated to refine models, but such data may suitably involve cross-referencing to a destination address, with cross-reference information being held securely and in confidence.

At step 310, collected data are used to create and refine a customer response predictor. The customer response predictor may suitably include real time customer data including data relating to customer activity and conditions relating to or affecting the customer, as well as customer profile data. At step 312, as conditions are arise that are appropriate to the selection and delivery of content, data from the predictor is used to select content and the content is delivered to a destination associated with the predictor.

While the present invention is disclosed in the context of a presently preferred embodiment, it will be recognized that a wide variety of implementations may be employed by persons of ordinary skill in the art consistent with the above discussion and the claims which follow below.

We claim:

1. A system for selecting and delivering content to a customer, comprising;
a plurality of interfaces each receiving data streams reflecting data transfer between one or more service providers and a customer;
an analyzer for examining each data stream to identify desired data and extract desired data therefrom;
a linkage and anonymization module for associating data from different data streams associated with the same customer and replacing customer identifying data with an anonymous identifier;
a storage facility for storing selected data extracted from the data streams;
a customer behavior predictor for a customer constructed by analyzing data extracted from the data streams associated with an identifier for predicting responsiveness with respect to content for a customer from whom data associated with that identifier was taken; and
a content manager for examining information associated with content that may be delivered to customers, and using information supplied by the customer behavior predictor to select appropriate content.

2. The system of claim 1, further comprising a facility for storing static customer data and using the static customer data in creating the customer behavior predictor.

3. The system of claim 2, further comprising a predictor and model creation module operative to receive customer data from the data streams and customer profile data to create and refine the customer behavior predictor.

4. The system of claim 3, wherein the content manager receives advertisement information from external entities, selects appropriate advertisements based on information received from the customer behavior predictor, and routes the selected advertisements to the customer associated with the predictor.

5. The system of claim 4, wherein construction of the customer behavior predictor includes examining and evaluating specific customer response to advertisements.

6. The system of claim 5, wherein examining and evaluating specific customer response to advertisements includes identifying occurrences of customer behavior that an advertisement presented to a customer seeks to elicit.

7. The system of claim 3, wherein the customer behavior predictor is associated with an anonymous identifier and wherein the content manager is further operative to direct content to a routing destination based on information correlating the routing destination with the anonymous identifier.

8. The system of claim 1, wherein the linkage and anonymization module is operative to analyze usage information to improve linkage accuracy.

9. The system of claim 1, wherein data relating to one or more of customer television, wireless, broadband, and wireline activities are used to predict and model customer responsiveness to content.

10. The system of claim 1, wherein data relating to conditions affecting the customer is collected and evaluated in order to predict and model customer responsiveness to content.

11. The system of claim 7, wherein data relating to direct observation of customer reaction to content is used to predict and model customer responsiveness to content.

12. The system of claim 7, wherein observations of behavior are made for customers other than a customer under consideration but who are determined to be statistically related to the customer under consideration, and wherein the observations of behavior for the customers statistically related to the customer under consideration are used to predict behavior for the customer under consideration.

13. The system of claim 12, wherein observations of behavior of customers are expressed in terms of factors and wherein factors operating at broader and narrower scales are used to predict behavior for a customer under consideration.

14. The system of claim 1, further comprising an interface for receiving data relating to conditions affecting the customer and wherein the content manager takes such data into account in selecting content for delivery to the customer.

15. The system of claim 5, wherein data relating to customer response to advertisements is aggregated and stored and wherein the aggregated data is analyzed to determine the effectiveness of targeted content delivery in improving customer response.

16. A method of customized content selection and delivery, comprising the steps of:
receiving a plurality of data streams each reflecting transfer of information between a service provider and a customer;
examining each data stream to extract desired data therefrom;
linking data from different data streams so as to associate data from different data streams associated with the same customer;
anonymizing data so as to replace data identifying a customer with an anonymous identifier;
storing the linked and anonymized data;
using the linked and anonymized data to create a customer behavior predictor providing data reflecting the responsiveness of a customer from whom the data was collected with respect to content proposed for delivery to that customer; and
using information relating to content that may be delivered to the customer, and information from the customer behavior predictor, to select content appropriate to the customer.

17. The method of claim 16, further comprising a step of receiving static customer data and using the static customer data in creating the customer behavior predictor.

18. The method of claim 17, further comprising steps of observing behavior for customers other than a customer under consideration but who are determined to be statistically related to the customer under consideration and using the observations of the statistically related customers to predict behavior for the customer under consideration.

19. The method of claim 16, wherein using information relating to content that may be delivered to the customer includes receiving advertisement information from external entities, and wherein selecting content appropriate to the customer includes selecting appropriate advertisements based on information received from the customer behavior predictor and routing the selected advertisements to the customer associated with the predictor.

20. The method of claim 16, wherein the customer behavior predictor is associated with an anonymous identifier and wherein content selected for the customer is directed to a routing destination based on information correlating the routing destination with the anonymous identifier.
